(19) United States
(12) Patent Application Publication
(10) Pub. No.: US 2018/0096028 A1
(43) Pub. Date: Apr. 5, 2018

(54) FRAMEWORK FOR MANAGEMENT OF MODELS BASED ON TENANT BUSINESS CRITERIA IN AN ON-DEMAND ENVIRONMENT

(71) Applicant: salesforce.com, inc., San Francisco, CA (US)

(72) Inventors: Chalenge Masekera, San Francisco, CA (US); Simon Chan, Belmont, CA (US); Kit Pang Szeto, Sunnyvale, CA (US)

(21) Appl. No.: 15/713,069

(22) Filed: Sep. 22, 2017

Related U.S. Application Data
(60) Provisional application No. 62/402,902, filed on Sep. 30, 2016.

(51) Int. Cl. G06F 17/30; G06F 21/62

(52) U.S. Cl. CPC G06F 17/30442; G06F 17/30536; G06F 21/6227

(57) ABSTRACT

In accordance with embodiments, there are provided mechanisms and methods for facilitating a framework for management of machine learning models for tenants in an on-demand services environment according to one embodiment. In one embodiment and by way of example, a method comprises determining, by a model management server computing device (“management device”), business criteria for a tenant in a multi-tenant environment, where the business criteria are based on business preferences of the tenant. The method may further include building, by the management device, multiple models dedicated to the tenant based on the business criteria such that each model is trained and fitted to perform one or more combinations of processes based on one or more integrations of the business criteria. The method may further include dynamically selecting, by the management device, a model from the multiple models to perform a combination of processes involving an integration of two or more criterion of the business criteria as requested by the tenant.

### CLAIM OF PRIORITY

This application is a continuation of U.S. Provisional Application No. 62/402,902 by Chalenge Masekera, et al., filed Sep. 30, 2016, the benefit of and priority to which are claimed thereof and the contents of which are incorporated herein by reference

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

One or more implementations relate generally to data management; more specifically, to facilitating a framework for management of machine learning models for tenants in an on-demand services environment.

### BACKGROUND

Even with wide availability of and advancement in processing frameworks, algorithm libraries, and data storage systems, conventional model building and training techniques lack efficiency and intelligence to handle different processes and environments.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The secure and efficient retrieval of accurate information and subsequent delivery of this information to the user system has been and continues to be a goal of administrators of database systems. Unfortunately, conventional database approaches are associated with various limitations.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates a system having a computing device employing a model management mechanism according to one embodiment.

FIG. 2 illustrates the model management mechanism of FIG. 1 according to one embodiment.

FIG. 3A illustrates a transaction sequence for facilitating building, selecting, and deploying of models according to one embodiment.

FIG. 3B illustrates a transaction sequence for facilitating building, selecting, and deploying of models according to one embodiment.

FIG. 3C illustrates a transaction sequence for facilitating building, selecting, and deploying of models according to one embodiment.

FIG. 3D illustrates a use case scenario for facilitating applying and managing models according to one embodiment.

FIG. 4 illustrates a method for facilitating building, selecting, and deploying of models according to one embodiment.

FIG. 5 illustrates a computer system according to one embodiment.

FIG. 6 illustrates an environment wherein an on-demand database service might be used according to one embodiment.

FIG. 7 illustrates elements of environment of FIG. 6 and various possible interconnections between these elements according to one embodiment.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Embodiments provide for a novel model management framework to generate and maintain a number and type of models for a tenant such that the models are capable of performing any number of processes based on any set of integration or combination of business criteria associated with and as preferred by the tenant.

It is contemplated that embodiments and their implementations are not merely limited to multi-tenant database system (“MTDBS”) and can be used in other environments, such as a client-server system, a mobile device, a personal computer (“PC”), a web services environment, etc. However, for the sake of brevity and clarity, throughout this document, embodiments are described with respect to a multi-tenant database system, such as Salesforce.com®, which is to be regarded as an example of an on-demand services environment. Other on-demand services environments include Salesforce® Exact Target Marketing Cloud™.

As used herein, a term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

In one embodiment, a multi-tenant database system utilizes tenant identifiers (IDs) within a multi-tenant environment to allow individual tenants to access their data while preserving the integrity of other tenant's data. In one embodiment, the multitenant database stores data for multiple client entities each identified by a tenant ID having one or more users associated with the tenant ID. Users of each of multiple client entities can only access data identified by a tenant ID associated with their respective client entity. In one embodiment, the multitenant database is a hosted database provided by an entity separate from the client entities, and provides on-demand and/or real-time database service to the client entities.

A tenant includes a group of users who share a common access with specific privileges to a software instance. A multi-tenant architecture provides a tenant with a dedicated share of the software instance typically including one or more of tenant specific data, user management, tenant-specific functionality, configuration, customizations, non-functional properties, associated applications, etc. Multi-tenancy contrasts with multi-instance architectures, where separate software instances operate on behalf of different tenants.

Embodiments are described with reference to an embodiment in which techniques for facilitating management of data in an on-demand services environment are implemented in a system having an application server providing a front end for an on-demand database service capable of supporting multiple tenants, embodiments are not limited to multi-tenant databases nor deployment on application servers. Embodiments may be practiced using other database architectures, i.e., ORACLE®, DB2® by IBM and the like without departing from the scope of the embodiments claimed.

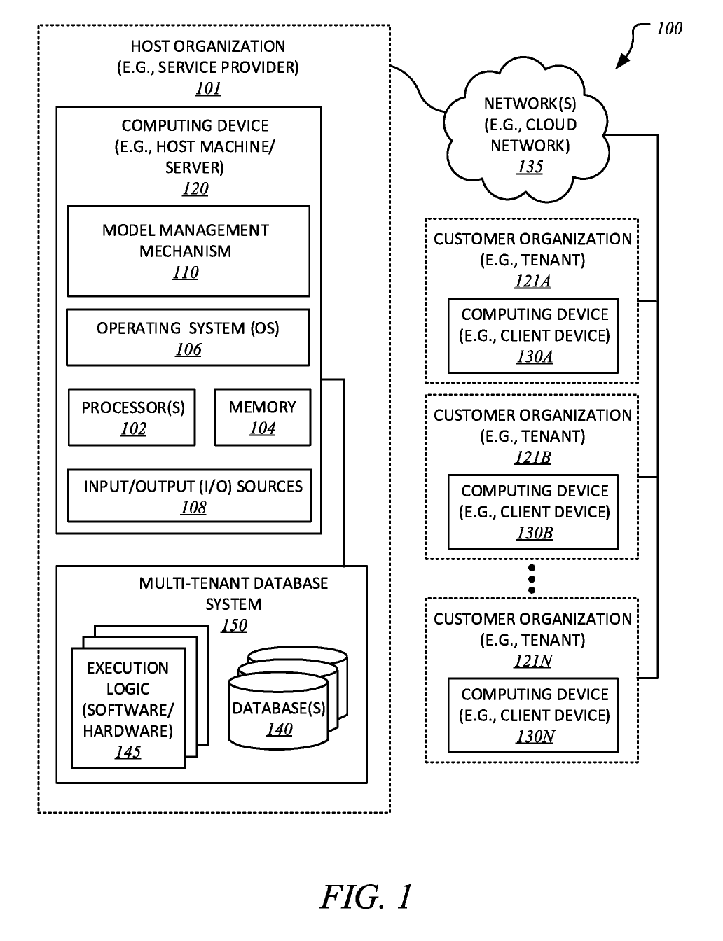

FIG. 1 illustrates a system 100 having a computing device 120 employing a model management mechanism 110 according to one embodiment. As illustrated, in one embodiment, computing device 120, being part of host organization 101 (e.g., service provider, such as Salesforce.com®), represents or includes a server computer acting as a host machine for employing model management mechanism 110 for facilitating smart deployment of metadata packages in a multi-tiered, multi-tenant, on-demand services environment.

It is to be noted that terms like “queue message”, “job”, “query”, “request” or simply “message” may be referenced interchangeably and similarly, terms like “job types”, “message types”, “query type”, and “request type” may be referenced interchangeably throughout this document. It is to be further noted that messages may be associated with one or more message types, which may relate to or be associated with one or more customer organizations, such as customer organizations 121A-121N, where, as aforementioned, throughout this document, “customer organizations” may be referred to as “tenants”, “customers”, or simply “organizations”. An organization, for example, may include or refer to (without limitation) a business (e.g., small business, big business, etc.), a company, a corporation, a non-profit entity, an institution (e.g., educational institution), an agency (e.g., government agency), etc.), etc., serving as a customer or client of host organization 101 (also referred to as “service provider” or simply “host”), such as Salesforce.com®, serving as a host of model management mechanism 110.

Similarly, the term “user” may refer to a system user, such as (without limitation) a software/application developer, a system administrator, a database administrator, an information technology professional, a program manager, product manager, etc. The term “user” may further refer to an end-user, such as (without limitation) one or more of customer organizations 121A-N and/or their representatives (e.g., individuals or groups working on behalf of one or more of customer organizations 121A-N), such as a salesperson, a sales manager, a product manager, an accountant, a director, an owner, a president, a system administrator, a computer programmer, an information technology (“IT”) representative, etc.

Computing device 120 may include (without limitation) server computers (e.g., cloud server computers, etc.), desktop computers, cluster-based computers, set-top boxes (e.g., Internet-based cable television set-top boxes, etc.), etc. Computing device 120 includes an operating system (“OS”) 106 serving as an interface between one or more hardware/physical resources of computing device 120 and one or more client devices 130A-130N, etc. Computing device 120 further includes processor(s) 102, memory 104, input/output (“I/O”) sources 108, such as touchscreens, touch panels, touch pads, virtual or regular keyboards, virtual or regular mice, etc.

In one embodiment, host organization 101 may further employ a production environment that is communicably interfaced with client devices 130A-N through host organization 101. Client devices 130A-N may include (without limitation) customer organization-based server computers, desktop computers, laptop computers, mobile computing devices, such as smartphones, tablet computers, personal digital assistants, e-readers, media Internet devices, smart televisions, television platforms, wearable devices (e.g., glasses, watches, bracelets, smartcards, jewelry, clothing items, etc.), media players, global positioning system-based navigation systems, cable setup boxes, etc.

In one embodiment, the illustrated multi-tenant database system 150 includes database(s) 140 to store (without limitation) information, relational tables, datasets, and underlying database records having tenant and user data therein on behalf of customer organizations 121A-N (e.g., tenants of multi-tenant database system 150 or their affiliated users). In alternative embodiments, a client-server computing architecture may be utilized in place of multi-tenant database system 150, or alternatively, a computing grid, or a pool of work servers, or some combination of hosted computing architectures may be utilized to carry out the computational workload and processing that is expected of host organization 101.

The illustrated multi-tenant database system 150 is shown to include one or more of underlying hardware, software, and logic elements 145 that implement, for example, database functionality and a code execution environment within host organization 101. In accordance with one embodiment, multi-tenant database system 150 further implements databases 140 to service database queries and other data interactions with the databases 140. In one embodiment, hardware, software, and logic elements 145 of multi-tenant database system 130 and its other elements, such as a distributed file store, a query interface, etc., may be separate and distinct from customer organizations (121A-121N) which utilize the services provided by host organization 101 by communicably interfacing with host organization 101 via network(s) 135 (e.g., cloud network, the Internet, etc.). In such a way, host organization 101 may implement on-demand services, on-demand database services, cloud computing services, etc., to subscribing customer organizations 121A-121N.

In some embodiments, host organization 101 receives input and other requests from a plurality of customer organizations 121A-N over one or more networks 135; for example, incoming search queries, database queries, application programming interface (“API”) requests, interactions with displayed graphical user interfaces and displays at client devices 130A-N, or other inputs may be received from customer organizations 121A-N to be processed against multi-tenant database system 150 as queries via a query interface and stored at a distributed file store, pursuant to which results are then returned to an originator or requestor, such as a user of client devices 130A-N at any of customer organizations 121A-N.

As aforementioned, in one embodiment, each customer organization 121A-N is an entity selected from a group consisting of a separate and distinct remote organization, an organizational group within host organization 101, a business partner of host organization 101, a customer organization 121A-N that subscribes to cloud computing services provided by host organization 101, etc.

In one embodiment, requests are received at, or submitted to, a web server within host organization 101. Host organization 101 may receive a variety of requests for processing by host organization 101 and its multi-tenant database system 150. For example, incoming requests received at the web server may specify which services from host organization 101 are to be provided, such as query requests, search request, status requests, database transactions, graphical user interface requests and interactions, processing requests to retrieve, update, or store data on behalf of one of customer organizations 121A-N, code execution requests, and so forth. Further, the web-server at host organization 101 may be responsible for receiving requests from various customer organizations 121A-N via network(s) 135 on behalf of the query interface and for providing a web-based interface or other graphical displays to one or more end-user client devices 130A-N or machines originating such data requests.

Further, host organization 101 may implement a request interface via the web server or as a stand-alone interface to receive requests packets or other requests from the client devices 130A-N. The request interface may further support the return of response packets or other replies and responses in an outgoing direction from host organization 101 to one or more client devices 130A-N.

It is to be noted that any references to software codes, data and/or metadata (e.g., Customer Relationship Model (“CRM”) data and/or metadata, etc.), tables (e.g., custom object table, unified index tables, description tables, etc.), computing devices (e.g., server computers, desktop computers, mobile computers, such as tablet computers, smartphones, etc.), software development languages, applications, and/or development tools or kits (e.g., Force.com®, Force.com Apex™ code, JavaScript™, jQuery™, Developerforce™, Visualforce™, Service Cloud Console Integration Toolkit™ (“Integration Toolkit” or “Toolkit”), Platform on a Service™ (“PaaS”), Chatter® Groups, Sprint Planner®, MS Project®, etc.), domains (e.g., Google®, Facebook®, LinkedIn®, Skype®, etc.), etc., discussed in this document are merely used as examples for brevity, clarity, and ease of understanding and that embodiments are not limited to any particular number or type of data, metadata, tables, computing devices, techniques, programming languages, software applications, software development tools/kits, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, “multi-tenant on-demand data system”, and the like, may be used interchangeably throughout this document. It is to be further noted that terms like “code”, “software code”, “application”, “software application”, “program”, “software program”, “package”, “software code”, “code”, and “software package” may be used interchangeably throughout this document. Moreover, terms like “job”, “input”, “request”, and “message” may be used interchangeably throughout this document.

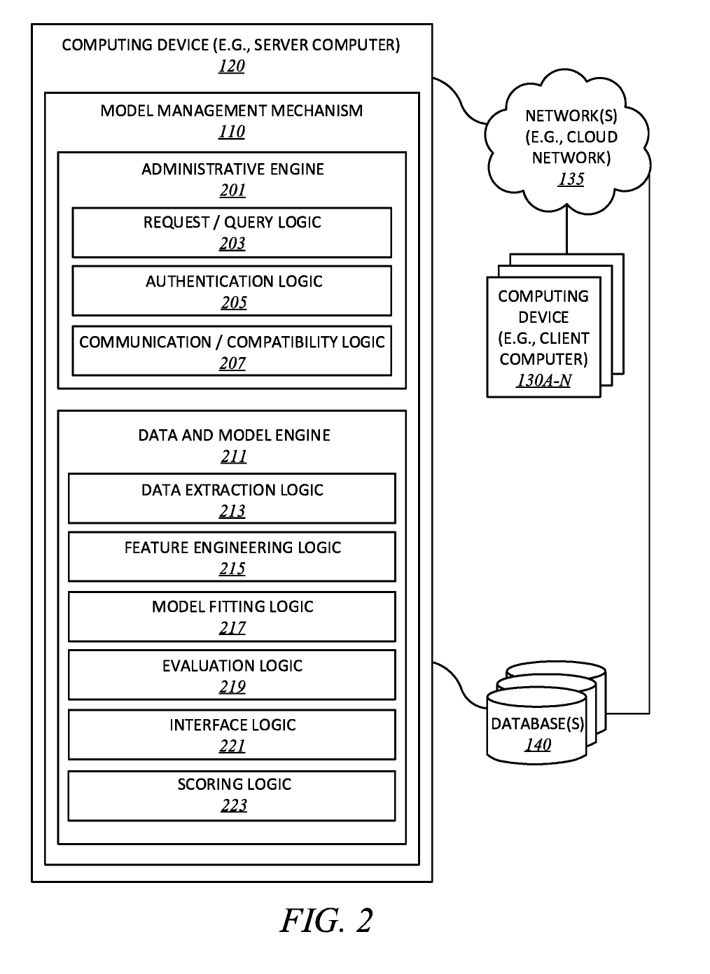

FIG. 2 illustrates model management mechanism 110 of FIG. 1 according to one embodiment. In one embodiment, model management mechanism 110 may include any number and type of components, such as administration engine 201 having (without limitation): request/query logic 203; authentication logic 205; and communication/compatibility logic 207. Similarly, model management mechanism 110 may further include data and model engine 211 including (without limitation): data extraction logic 213; feature engineering logic 215; model fitting logic 217; evaluation logic 219; interface logic 221; and scoring logic 223.

In one embodiment, computing device 120 may serve as a service provider core (e.g., Salesforce.com® core) for hosting and maintaining model management mechanism 110 and be in communication with one or more database(s) 140, one or more client computer(s) 130A-N, over one or more network(s) 135, and any number and type of dedicated nodes.

Throughout this document, terms like “framework”, “mechanism”, “engine”, “logic”, “component”, “module”, “tool”, and “builder” may be referenced interchangeably and include, by way of example, software, hardware, and/or any combination of software and hardware, such as firmware. Further, any use of a particular brand, word, or term, such as “metadata”, “metadata package”, “deployment”, “deployment cost”, “characteristics”, “criteria”, “cost criteria”, “cost engine”, “matching”, “comparing”, “evaluating”, “analyzing”, “profiling”, “selecting”, “deciding”, “routing”, “generating”, “maintaining”, “routes”, “paths”, “queues”, “queuing”, “enqueuing”, “dequeuing”, “query failure”, “latency”, “predictability”, “time frame”, “size”, “customization”, “testing”, “updating”, “upgrading”, etc., should not be read to limit embodiments to software or devices that carry that label in products or in literature external to this document.

As aforementioned, with respect to FIG. 1, any number and type of requests and/or queries may be received at or submitted to request/query logic 203 for processing. For example, incoming requests may specify which services from computing device 120 are to be provided, such as query requests, search request, status requests, database transactions, graphical user interface requests and interactions, processing requests to retrieve, update, or store data, etc., on behalf of one or more client device(s) 130A-N, code execution requests, and so forth.

In one embodiment, computing device 120 may implement request/query logic 203 to serve as a request/query interface via a web server or as a stand-alone interface to receive requests packets or other requests from the client device(s) 130A-N. The request interface may further support the return of response packets or other replies and responses in an outgoing direction from computing device 120 to one or more client device(s) 130A-N.

Similarly, request/query logic 203 may serve as a query interface to provide additional functionalities to pass queries from, for example, a web service into the multi-tenant database system for execution against database(s) 140 and retrieval of customer data and stored records without the involvement of the multi-tenant database system or for processing search queries via the multi-tenant database system, as well as for the retrieval and processing of data maintained by other available data stores of the host organization's production environment. Further, authentication logic 205 may operate on behalf of the host organization, via computing device 120, to verify, authenticate, and authorize, user credentials associated with users attempting to gain access to the host organization via one or more client device(s) 130A-N.

In one embodiment, computing device 120 may include a server computer which may be further in communication with one or more databases or storage repositories, such as database(s) 140, which may be located locally or remotely over one or more networks, such as network(s) 235 (e.g., cloud network, Internet, proximity network, intranet, Internet of Things (“IoT”), Cloud of Things (“CoT”), etc.). Computing device 120 is further shown to be in communication with any number and type of other computing devices, such as client computing devices) 130A-N, over one or more communication mediums, such as network(s) 140.

As previously discussed, the advent of bid data analytics has sparked interest in the design of machine learning systems and smart applications. However, even with the wide availability of processing frameworks, algorithm libraries, and data storage systems, various issues exist in bringing machine learning applications from prototyping into production. In addition to data integration and system scalability, real-time deployment of predictive engines in a possibly distributed environment requires necessitates dynamic query responses, live model update with new data, inclusion of business logics, intelligent and live evaluation, and tuning of predictive engines to update the underlying predictive models or algorithms to generate new engine variants.

Further, existing tools for building machine learning systems often provide encapsulated solutions, where such encapsulations make it unfeasible to identify causes for inaccurate prediction results. It is also difficult to extensively track sequences of events that trigger particular prediction results.

Since each tenant in a multi-tenant environment is expected to have their own protocols and preferences, conventional techniques fail to recognize that variance and diversity, which, in turn leads to teams of system developers and data scientists trying to generate and tune each machine learning model to fit as much of the tenant's needs as possible. Such processes are, however, time consuming, cumbersome, and prone to human errors.

Embodiments provide for a novel model management framework, as facilitated by model management mechanism 110, to generate and maintain any number and type of models for a tenant such that the models are capable of performing any number and type of processes based on any set of integration or combination of business criteria associated with and as preferred by the tenant.

Conventional techniques are known for consuming a great deal of time on data manipulation (e.g., data cleaning, data formatting, combining features, transforming features, etc.).

Described here are novel techniques for building and/or providing of machine learning models in which components are reusable to reduce the amount of time typically needed to create individual models. A more modular approach for generating models can result in more structure and reusable components. In one embodiment, models and evaluations is made more utilitarian by wrapping them in interfaces that take standard data inputs.

The novel techniques and components described throughout this document may provide reusable pieces, such as simple base classes that can be used for a broad range of modeling. Further, type safety can be provided. In one embodiment, as will be further described later, model fitting or training may return an object that transforms the data by scoring. Similarly, in one embodiment, a uniform model management mechanism may be used for passing of parameters. Further, in one embodiment, evaluation of data may also be included in this novel model generation technique, where interaction is facilitated for bringing data into this model management mechanism, such as for getting data in and sending data out of this mechanism at a model management server computing device, such as computing device 120.

Further, in one embodiment, resilient distributed datasets (RDDs) may be used for data management; however, other techniques (e.g., DataFrames) may also be supported. In one embodiment, transformations are bundled such that these transformations do not have to be strung together. In one embodiment, many data libraries are also supported, while input and output connectors are maintained general enough to take data in from several sources and to provide data to several sources.

In one embodiment, model management mechanism 110 provides for a novel enterprise-grate machine learning model (“model”) management tool that integrates with software control management systems and continuous integration infrastructures. This novel technique provides for components and architectures for tracking deployment of a predictive engine, including deployment of a variant of the predictive engine based on an engine parameter set, where the engine parameter set identifies at least one data source and at least one strategy.

In one embodiment, model management mechanism 110 is agnostic to machine learning technology stacks and programming languages, allowing management of models produced by different technologies and environments. Further, this novel technique provides for reproducing historical models for auditing, debugging, delayed evaluation, and state rollback with automatic version control and tracking.

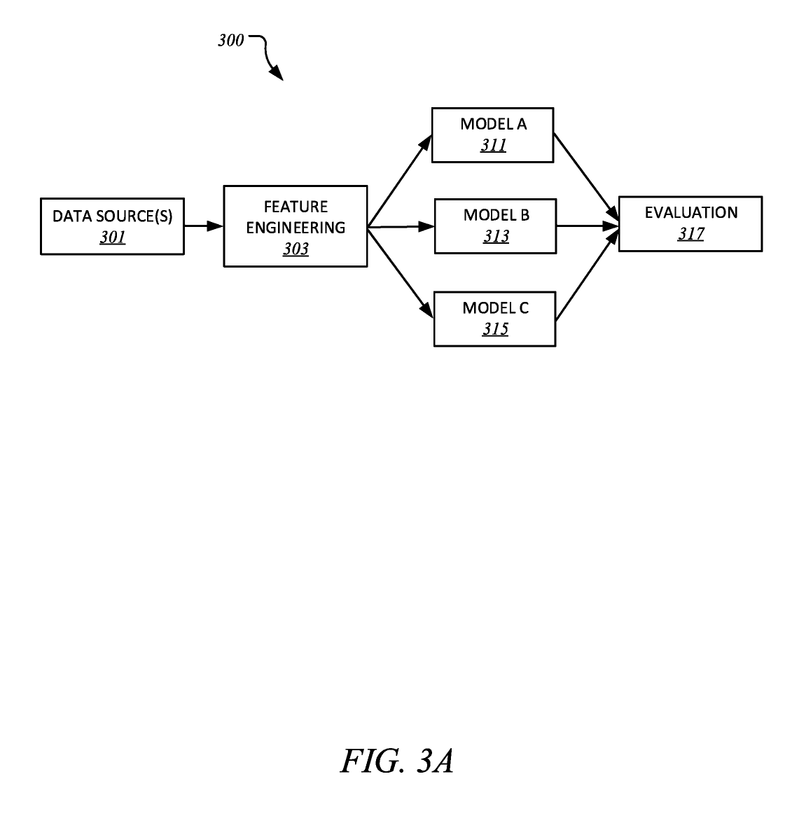

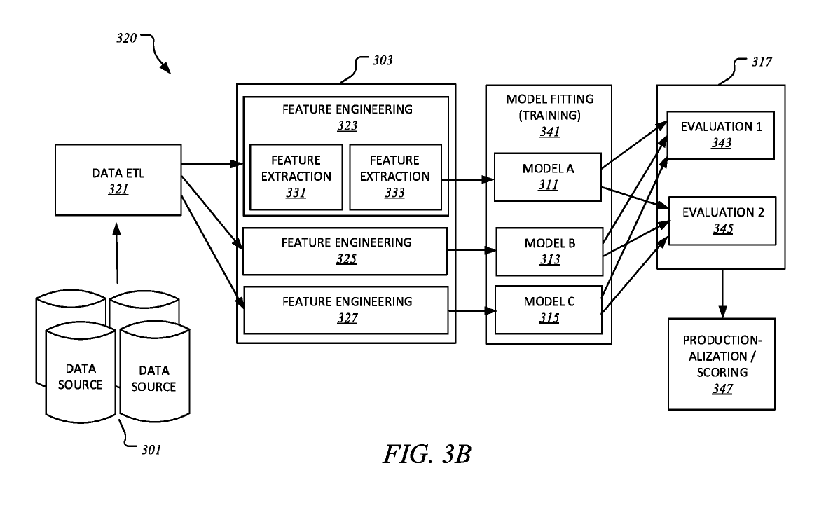

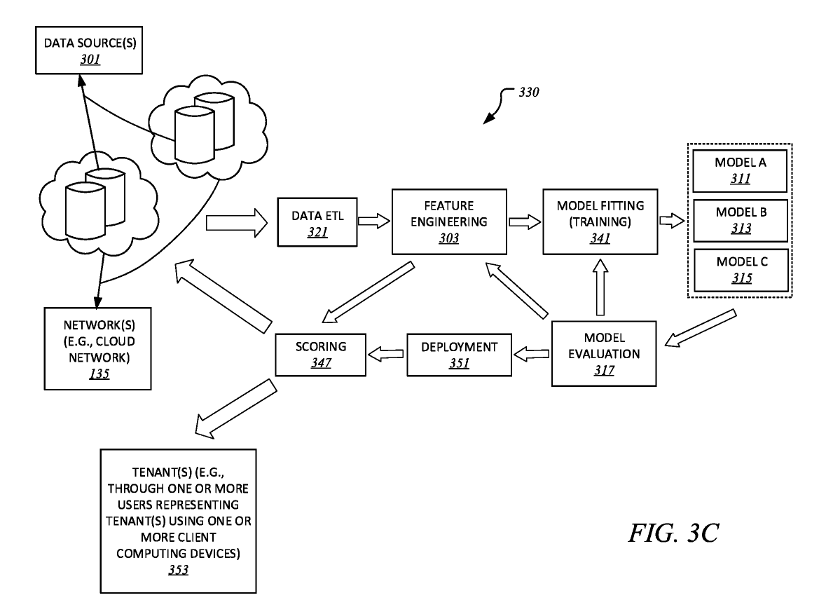

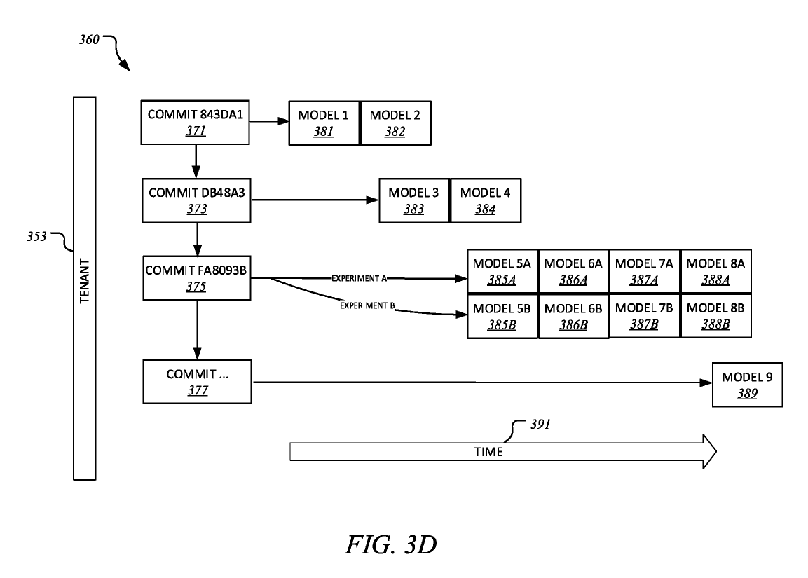

In one embodiment, as will be further described with reference to FIGS. 3A-3B, model management mechanism 110 includes data and model engine 211 for performing any number and type of processes relating to data and machine learning models. For example, data extraction logic 213 of data and model engine 211 may be used for extraction of relevant data from one or more data sources, such as databases 140, where this data may be relevant to tenants and/or their customers. For example, this data may include data record or information relating to tenants, such as their products, services, protocols, preferences, marketing plan, business models, etc. Similarly, the data may also or alternatively include information relating to the tenants' customers, such as behavior traits of customers in relating to various products and/or services of one or more tenants, customer demographics, geographic locations, etc.

Once the data is acquired or extracted by data extraction logic 213 from databases 140, it is then forwarded on to feature engineering logic 215 to perform any feature engineering-related tasks. In one embodiment, feature engineering, as facilitated by feature engineering logic 215, may include tasks like extraction of features from the data. These extracted features may include some of information described above, such as features relating to a tenant's products, services, protocols, preferences, business models, marketing plans, and/or the like. Similarly, certain features may include information about various customers (such as features indirectly related to tenants), such as a customer's behavior traits as they relate to products and/or services, demographics, geographic locations, etc.

As will be later described, these features, in one embodiment, may then be used to create machine learning models that are relevant or best fitted to certain tenants. For example, there may be any number of models generated and managed and kept available such that one or more best-fitted models are selected and assigned to a tenant depending on the feature-based information available about the tenant.

Embodiments provide for a novel and intelligent technique that offers single management framework for generating and maintaining machine learning models along with having the ability to select those models that are best fitted for tenants, such as model 1 and 2 for tenant A and B, respectively, based on their extracted and transformed features and any other relevant information.

Continuing with feature engineering logic 215, it provides for a feature extraction component to perform extraction of features from the available data as described above. Once the relevant features are extracted from the data, a feature transformation component of feature engineering logic 215 may be used to transform the features from being raw data into intelligent information that can be useful for generation and selection of models and for other purposes, such as predictions. For example, transforming of features may include determining whether the extracted features are accurate, current, require modification, transformable to a more relevant set of information, qualify or comply with the tenant preferences, rules and regulations, business protocols, etc. For example, the only relevant data may be of those customers who are no less than the age of 15 and no more than the age of 55. In this case, feature transformation may include eliminating or ignoring any information that relates to customers of age under 15 and over 55. Similarly, certain features may be verified or scrutinized, such as names, ages, genders, product descriptions, service areas, and/or the like.

This transformed information obtained through feature transformation by feature transformation component of feature engineering logic 215 may then be used, by model fitting logic (also referred to as “model training logic”) 217, for training or tuning of models leading from generation of new models to modification of or selection from existing models, etc. For example, any transformed information may be forwarded on to model fitting logic 217 to determine, train, and select a model for a tenant so that the tenant may be provided with the best fitted model to perform any machine learning and/or other tasks using the best fitted model.

Once a model is selected, evaluation logic 219 may then be triggered to perform evaluation or analysis of the selected model. For example, evaluation provides an additional layer of analysis before the model is finally fitted for the tenant. In one embodiment, evaluation by evaluation logic 219 includes verifying the selected model to determine whether the model is created well and capable of performing the tasks for the relevant tenant. For example, evaluation logic 219 performs any number and type of tests on the selected model to determine if the model passes or fails in relation to the tenant for which it is selected.

If the model fails its evaluation tests, evaluation logic 219 rejects the selected model and prevents it from going forward and returns the process back to feature engineering logic 215 or model fitting logic 217, etc. If, however, the selected model passes the evaluation tests, evaluation logic 219 forwards the model to scoring logic 223. In one embodiment, scoring logic 223 may receive the model from evaluation logic 219 and gets it ready for the tenant and/or production. In other words, once the model is finally selected and passed on to the tenant, the tenant may then use the model for any number and type of tasks, such as analysis of customer data, generating predications based on the customer data, and performing other machine learning processes, and/or the like.

Further, in one embodiment, interface logic 221 may be used to facilitate interfacing between various components of model management mechanism 110 as well as with other components and/or devices, such as one or more database(s) 140. Similarly, in one embodiment, interface logic 221 may be used to facilitate and support user interface(s) at one or more computing device(s) 130A-N so that any queries associated with processing and deployment of metadata packages may be placed, while its results, may be accessed and/or viewed by users through such user interface(s) at one or more computing device(s) 130A-N. It is contemplated that the one or more interfaces are not limited to any particular number or type of interfaces such that an interface may include (without limitations) any one or more of a user interface (e.g., Web browser, Graphical User Interface (GUI), software application-based interface, etc.), an application programming interface (API), a Representational State Transfer (REST) or RESTful API, and/or the like.

It is contemplated that a tenant may include an organization of any size or type, such as a business, a company, a corporation, a government agency, a philanthropic or non-profit entity, an educational institution, etc., having single or multiple departments (e.g., accounting, marketing, legal, etc.), single or multiple layers of authority (e.g., C-level positions, directors, managers, receptionists, etc.), single or multiple types of businesses or sub-organizations (e.g., sodas, snacks, restaurants, sponsorships, charitable foundation, services, skills, time etc.) and/or the like.

Communication/compatibility logic 207 may facilitate the ability to dynamically communicate and stay configured with any number and type of software/application developing tools, models, data processing servers, database platforms and architectures, programming languages and their corresponding platforms, etc., while ensuring compatibility with changing technologies, parameters, protocols, standards, etc.

It is contemplated that any number and type of components may be added to and/or removed from model management mechanism 110 to facilitate various embodiments including adding, removing, and/or enhancing certain features. It is contemplated that embodiments are not limited to any particular technology, topology, system, architecture, and/or standard and are dynamic enough to adopt and adapt to any future changes.

FIG. 3A illustrates a transaction sequence 300 for facilitating building, selecting, and deploying of models according to one embodiment. Transaction sequence 300 may be performed by processing logic that may comprise hardware (e.g., circuitry, dedicated logic, programmable logic, etc.), software (such as instructions run on a processing device), or a combination thereof. In one embodiment, transaction sequence 300 may be performed or facilitated by one or more components of model management mechanism 110 of FIGS. 1-2. The processes of transaction sequence 300 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-2 may not be repeated or discussed hereafter.

In the illustrated embodiment, transaction sequence 300 begins with collection or extraction of data from data source(s) 301, such as one or more databases 140 of FIGS. 1-2, etc. It is contemplated that data source(s) 301 are limited to merely database(s) 140 and that any number and type of other data sources, such as electronic communication, websites, etc., may be used for collection or extraction of data that is relevant to tenants, customers, etc. As described with reference to FIG. 2, this acquired data from one or more data source(s) 301 is then put through the process of feature engineering 303 that further includes processes of features extraction and features transformation. The outputs from the process feature engineering 303 are used as inputs into the process of model fitting and/or training to obtain and/or select models A 311, B 313, and C 315, etc.

These models 311, 313, 315 are then put through the process of evaluation 317 to perform evaluation or analysis of results obtained from model fitting of models 311, 313, 315, which leads to verifying and testing of each of models 311, 313, 315. This process of evaluation 317 produces the best fitted of models 311, 313, 315 for the tenant to utilized for their purposes.

FIG. 3B illustrates a transaction sequence 320 for facilitating building, selecting, and deploying of models according to one embodiment. Transaction sequence 320 may be performed by processing logic that may comprise hardware (e.g., circuitry, dedicated logic, programmable logic, etc.), software (such as instructions run on a processing device), or a combination thereof. In one embodiment, transaction sequence 320 may be performed or facilitated by one or more components of model management mechanism 110 of FIGS. 1-2. The processes of transaction sequence 320 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-3A may not be repeated or discussed hereafter.

As illustrated and discussed with reference to FIG. 3A, this illustration further illustrates building and selection of machine learning models for tenants to perform any number and type of processes with regard to their customers in relation to their products and/or services. For example, transaction sequence 320 begins with extraction of data extract, transform, load (ETL) 321 from one or more data source(s) 301. In one embodiment, this data is then put through feature engineering 303, which may include a number of feature engineering processes on parts of the extracted data, such as feature engineering 323, 325, 327. As previously described, each process of feature engineering 323, 325, 327 may include processes of feature extraction and feature transformation, such as feature extraction 331 and feature transformation 333 of feature engineering 323.

As illustrated, the outputs of feature engineering 323, 325, and 327 may be used as inputs for processes of model fitting and/or training 341 for corresponding models A 311, B 313, and C 315, respectively. Upon training and/or tuning of models 311, 313, 315 through model fitting 341, the resulting data is then offered for evaluation 317. In one embodiment, evaluation 317 may include one or more evaluations, such as evaluation 1 343 and 2 345 to processes the model fitting results associated with models 311, 313, and 315. Further, in one embodiment, the results of the processes of evaluations 343, 345 may then be fed back to one or more of feature engineering 323, 325, 327 if one or more of models 311, 313, 315 fails in their evaluation 343, 345 or forwarded on to the processes of productionalization (or simply “production”) and/or scoring 347 if one or more of models 311, 313, 315 pass their evaluation 343, 345. Upon scoring 347, a finalized version of the one or more models 311, 313, 315 is then provided to one or more tenants to utilize their models 311, 313, 315 for any number and type of processes to better serve their existing clients and/or market their prospective clients.

FIG. 3C illustrates a transaction sequence 350 for facilitating building, selecting, and deploying of models according to one embodiment. Transaction sequence 350 may be performed by processing logic that may comprise hardware (e.g., circuitry, dedicated logic, programmable logic, etc.), software (such as instructions run on a processing device), or a combination thereof. In one embodiment, transaction sequence 350 may be performed or facilitated by one or more components of model management mechanism 110 of FIGS. 1-2. The processes of transaction sequence 350 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-3B may not be repeated or discussed hereafter.

As illustrated, transaction sequence 350 begins with acquiring data 321 from one or more data source(s) 301 and then putting the acquired data through feature engineering 303. In one embodiment, model fitting and/or training is performed on the feature engineered data such that models A 311, B 313, and C 315 are produced. These models 311, 313, 315 are then put through model evaluation 317 for further verification and certification and any of models 311, 313, 315 successfully emerging from evaluation 317 is/are then considered fitted and subsequently deployed 351. As discussed earlier, scoring 347 is performed on one or more of models 311, 313, 315 and allowed to be utilized by tenant 353, such as one or more end-users (e.g., data scientists, software developers, sales director, production manager, etc.) representing a tenant via one or more client computing devices 130A-N. In some cases, any scoring data may be fed back into one or more data source(s) 301 for future reference and/or use.

FIG. 3D illustrates a use case scenario 360 for facilitating applying and managing models according to one embodiment. Transaction sequence 360 may be performed by processing logic that may comprise hardware (e.g., circuitry, dedicated logic, programmable logic, etc.), software (such as instructions run on a processing device), or a combination thereof. In one embodiment, transaction sequence 360 may be performed or facilitated by one or more components of model management mechanism 110 of FIGS. 1-2. The processes of transaction sequence 360 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-3C may not be repeated or discussed hereafter.

The illustrated embodiment offers use case scenario 360 in which models may be managed. For example, tenant 353 owns a repository in a version control system (e.g., Git) containing, for example, machine learning code that produces models, such as models 1 381, 2 382, 3 383, 4 384, 5a 385A, 5b 385B, 6a 386A, 6b 386B, 7a 387A, 7b 387B, 8a 388A, 8b 388B, and 9 389. In one embodiment, solution associates itself with tenant 361 and a repository, such as one or more databases 140 of FIGS. 1-2. For example, users associated with tenant 361 can run code from different commits 371, 373, 375, and 377 to produce models 381-382, 383-384, 385A-388B, and 389, respectively. Advanced users may define multiple data sources and experiments to run in parallel (such as models 385A, 385B, etc.), where any number of tenants, such as tenant 353, may be supported in an analogous manner.

In some embodiments, one or more of the following features may be provided: 1) model versioning and release management, continuous controlled model evaluation, monitoring and deployment, and/or multi-tenant support for enterprise software as a service (SaaS).

In one embodiment, the techniques and mechanisms, as facilitated by model management mechanism 110, described herein facilitate reproducing historical models for auditing, debugging, delayed evaluation and statue rollback with automatic version control and tracking. Using this technique to produce models, a user may have confidence to pinpoint the software version that produced a particular model, time when the models were produced, the experiment and training data source that produced the particular model, and/or the owner-tenant of the models.

In one embodiment, the techniques and processes, as facilitated by model management mechanism 110, described herein ensure newly trained models meet pre-defined business and production necessities, such as integrated with most continuous integration (CI) and alerting systems. The novel techniques described herein can even leverage existing infrastructure to control model evaluation and deployment, where multiple evaluations and deployments may run simultaneously. In one embodiment, the novel techniques and mechanism provide control over evaluation and deployment schedulers. In one embodiment, model management mechanism 110 is further to define alerts when any evaluation fails to meet expectations, while automation for deployment of new models is defined after they have passed evaluations defined by a user.

In one embodiment, this novel technique, as facilitated by model management mechanism 110, further allows for streamlining of logistics of training and serving predictive models for multiple customers in an application. For example, in the case of service and/or environment providers that service multiple types of clients (e.g., Salesforce.com® and other such SaaS companies), with customizable platforms, each customer may use the platform very differently, such as in a manner tuned for their particular sales, service, and marketing processes. Further, privacy concerns and the nature of SaaS business may mean that any cross-pollination of data across different customers may not be desired or allowed. Therefore, any customer-facing a predictive application may not rely on a single, global machine learnt model, and instead rely on unique models personalized for each tenant and/or customer.

Consider, for example, a scenario where a customer relationship management (CRM) provider may like to build an application that predicts the likelihood for a sales lead to convert. The stages that a lead goes through, from the point of entering the system up until the point that it converts may vary from tenant to tenant as the rate of conversion for each tenant from another tenant may be very high and the average length of time it takes to convert may also be very different.

Embodiments provide for a highly scalable model management framework, as facilitated by model management mechanism 110, to each machine to do machine learning and in turn, automating the tasks that typically a data scientist would do on a day-to-day basis. In some embodiments, the framework provides processes for one or more of automatic feature generation, automatic feature transformation (including missing value computation), smart binning, feature normalization, interaction features, automated removal of highly correlated features to prevent label leakage, automated rebalancing of unbalanced training data, automated hyper parameter tuning and optimization, automated model selection and/or automatic calibration of predictive scores, and/or the like.

Embodiments provide for quicker modeling turnarounds with higher accuracy than general purpose modeling libraries and for any given predictive application, efficient personalized models may be built for individual customers and/or tenants.

In general, machine learning may involve using algorithms to decide how to perform tasks by generalizing from examples. This may be feasible and cost-effective in situations where custom manual programming is not. However, developing successful machine learning applications necessitates substantial knowledge and background work. Further, for example, machine learning utilizes statistics to generalize examples. In other words, a conventional machine learning algorithm may not be blindly applied to raw data and lead to good results. Different types of problems necessitate different types of machine learning techniques and before applying such techniques, the data is needed to be analyzed, cleansed (such as removing any bad or unwanted or undesired data) and then manipulate the clean data so that the most predictive features come available and put into the corrected and/or expected format.

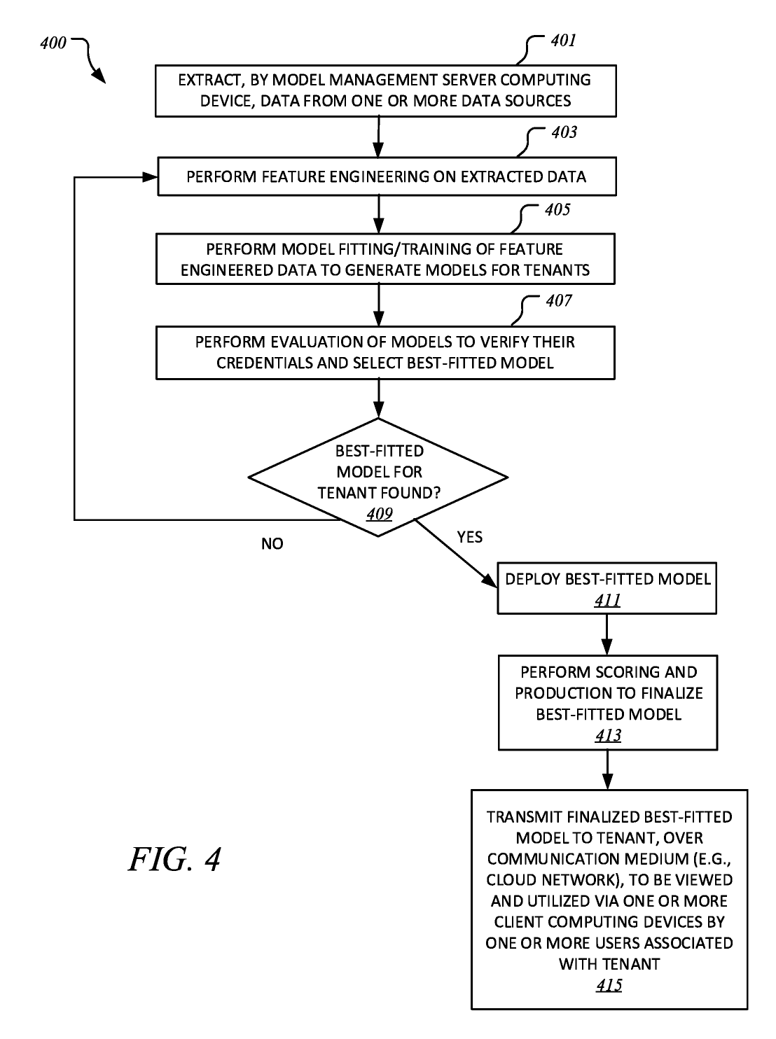

FIG. 4 illustrates a method 400 for facilitating building, selecting, and deploying of models according to one embodiment. Method 400 may be performed by processing logic that may comprise hardware (e.g., circuitry, dedicated logic, programmable logic, etc.), software (such as instructions run on a processing device), or a combination thereof. In one embodiment, method 400 may be performed or facilitated by one or more components of model management mechanism 110 of FIGS. 1-2. The processes of method 400 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-3D may not be repeated or discussed hereafter.

Method 400 begins at block 401 with extraction of data from one or more data sources, such as one or more databases 140 accessible from a server computing device, such as server computer 120, which is in communication with one or more client computing devices 130A-N associated with or accessible to one or more tenants as illustrated in FIGS. 1-2. Once the data is extracted, in one embodiment, feature engineering of the data is performed at block 403.

At block 405, in one embodiment, model fitting and/or training is performed on the feature engineered data to generate and/or select models relevant to tenants. At block 407, these models are then put through the process of model evaluation for further scrutiny and verification to determine which one or more of the models may be most appropriate or best fitted for a tenant. At block 409, based on the results of this evaluation, a determination is made as to whether there is best fitted model for the tenant. If all models have failed, method 400 is looped back to feature engineering at block 403. If, however, at least one model is picked as the best fitted model for the tenant, then this model is passed on for deployment at block 411. At block 413, scoring and production the model is performed so that at block 415, the finalized model may be transmitted on to the client for utilization.

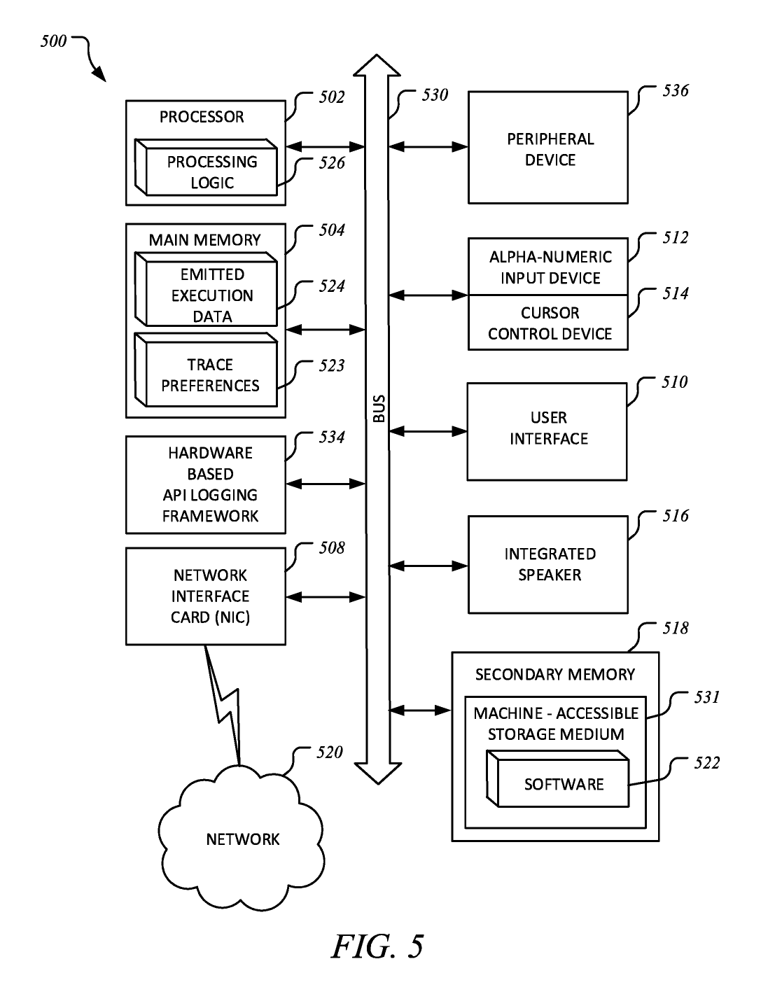

FIG. 5 illustrates a diagrammatic representation of a machine 500 in the exemplary form of a computer system, in accordance with one embodiment, within which a set of instructions, for causing the machine 500 to perform any one or more of the methodologies discussed herein, may be executed. Machine 500 is the same as or similar to computing devices 120, 130A-N of FIG. 1. In alternative embodiments, the machine may be connected (e.g., networked) to other machines in a network (such as host machine 120 connected with client machines 130A-N over network(s) 135 of FIG. 1), such as a cloud-based network, Internet of Things (IoT) or Cloud of Things (CoT), a Local Area Network (LAN), a Wide Area Network (WAN), a Metropolitan Area Network (MAN), a Personal Area Network (PAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 502, a main memory 504 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 518 (e.g., a persistent storage device including hard disk drives and persistent multi-tenant data base implementations), which communicate with each other via a bus 530. Main memory 504 includes emitted execution data 524 (e.g., data emitted by a logging framework) and one or more trace preferences 523 which operate in conjunction with processing logic 526 and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality of query mechanism 110 as described with reference to FIG. 1 and other Figures discussed herein.

The computer system 500 may further include a network interface card 508. The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), and a signal generation device 516 (e.g., an integrated speaker). The computer system 500 may further include peripheral device 536 (e.g., wireless or wired communication devices, memory devices, storage devices, audio processing devices, video processing devices, etc. The computer system 500 may further include a Hardware based API logging framework 534 capable of executing incoming requests for services and emitting execution data responsive to the fulfillment of such incoming requests.

The secondary memory 518 may include a machine-readable storage medium (or more specifically a machine-accessible storage medium) 531 on which is stored one or more sets of instructions (e.g., software 522) embodying any one or more of the methodologies or functions of query mechanism 110 as described with reference to FIG. 1, respectively, and other figures discussed herein. The software 522 may also reside, completely or at least partially, within the main memory 504 and/or within the processor 502 during execution thereof by the computer system 500, the main memory 504 and the processor 502 also constituting machine-readable storage media. The software 522 may further be transmitted or received over a network 520 via the network interface card 508. The machine-readable storage medium 531 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

The techniques shown in the figures can be implemented using code and data stored and executed on one or more electronic devices (e.g., an end station, a network element). Such electronic devices store and communicate (internally and/or with other electronic devices over a network) code and data using computer -readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

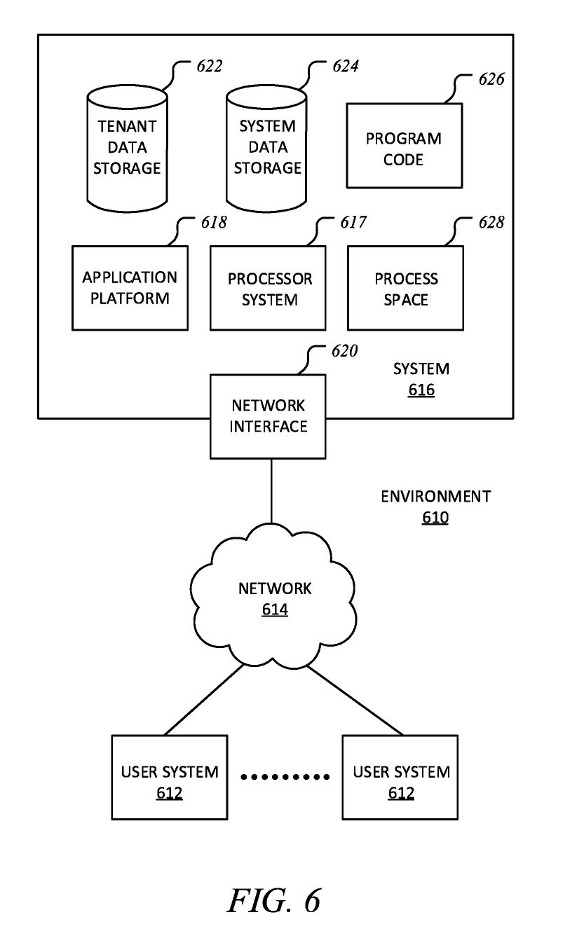

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

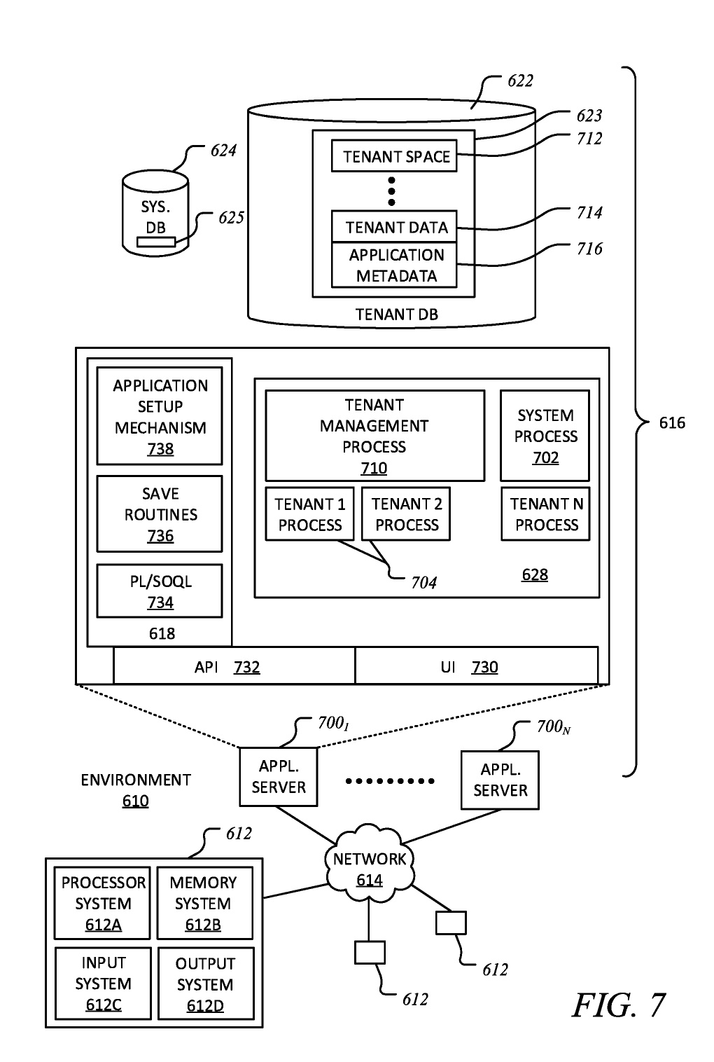

Environment 610 is an environment in which an on-demand database service exists. User system 612 may be any machine or system that is used by a user to access a database user system. For example, any of user systems 612 can be a handheld computing device, a mobile phone, a laptop computer, a workstation, and/or a network of computing devices. As illustrated in herein FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third-party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load-sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third-party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database-indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. User system 612 further includes Mobile OS (e.g., iOS® by Apple®, Android®, WebOS® by Palm®, etc.). Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Core® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A method comprising:
determining, by a model management server computing device (“management device”), business criteria for a tenant in a multi-tenant environment, wherein the business criteria are based on business preferences of the tenant;
building, by the management device, multiple models dedicated to the tenant based on the business criteria such that each model is trained and fitted to perform one or more combinations of processes based on one or more integrations of the business criteria; and
dynamically selecting, by the management device, a model from the multiple models to perform a combination of processes involving an integration of two or more criterion of the business criteria as requested by the tenant.

2. The method of claim 1, wherein the business criteria are further based on behavior traits of customers of the tenant.

3. The method of claim 1, further comprising extracting data from one or more data sources such that the business criteria are identified based on the extracted data, wherein the one or more data sources include one or more databases coupled to the management device.

4. The method of claim 2, further comprising feature engineering the data, wherein feature engineering comprises extracting features associated with at least one of the tenant and the customers, and transforming the extracted features into information offering one or more of the business preferences and the behavior traits.

5. The method of claim 1, further comprising evaluating credentials of the multiple models to determine suitably of each of the multiple models for the tenant, wherein passing a first model of the multiple models that is evaluated as suitable for the tenant and wherein failing a second model of the multiple models that is evaluated as unsuitable for the tenant.

6. The method of claim 5, further comprising transmitting the first model to the tenant for utilization of processes as determined by the tenant, wherein the first model is transmitted, over a communication network, to one or more client computing devices accessible to one or more users representing the tenant, wherein the second model is rejected and sent back for additional feature engineering, wherein the first and second models include machine learning models.

7. A database system comprising:
a model management server computing device (“management device”) having memory coupled to a processing device, the processing device to execute instructions to perform operations comprising:
determining business criteria for a tenant in a multi-tenant environment, wherein the business criteria are based on business preferences of the tenant;
building multiple models dedicated to the tenant based on the business criteria such that each model is trained and fitted to perform one or more combinations of processes based on one or more integrations of the business criteria; and
dynamically selecting a model from the multiple models to perform a combination of processes involving an integration of two or more criterion of the business criteria as requested by the tenant.

8. The system of claim 7, wherein the business criteria are further based on behavior traits of customers of the tenant.

9. The system of claim 7, wherein the operations further comprise extracting data from one or more data sources such that the business criteria are identified based on the extracted data, wherein the one or more data sources include one or more databases coupled to the management device.

10. The system of claim 8, wherein the operations further comprise feature engineering the data, wherein feature engineering comprises extracting features associated with at least one of the tenant and the customers, and transforming the extracted features into information offering one or more of the business preferences and the behavior traits.

11. The system of claim 7, wherein the operations further comprise evaluating credentials of the multiple models to determine suitably of each of the multiple models for the tenant, wherein passing a first model of the multiple models that is evaluated as suitable for the tenant and wherein failing a second model of the multiple models that is evaluated as unsuitable for the tenant.

12. The system of claim 11, wherein the operations further comprise transmitting the first model to the tenant for utilization of processes as determined by the tenant, wherein the first model is transmitted, over a communication network, to one or more client computing devices accessible to one or more users representing the tenant, wherein the second model is rejected and sent back for additional feature engineering, wherein the first and second models include machine learning models.

13. A machine-readable medium comprising a plurality of instructions which, when executed by a processing device, cause the processing device to perform operations comprising:
determining business criteria for a tenant in a multi-tenant environment, wherein the business criteria are based on business preferences of the tenant;
building multiple models dedicated to the tenant based on the business criteria such that each model is trained and fitted to perform one or more combinations of processes based on one or more integrations of the business criteria; and
dynamically selecting a model from the multiple models to perform a combination of processes involving an integration of two or more criterion of the business criteria as requested by the tenant.

14. The machine-readable medium of claim 13, wherein the business criteria are further based on behavior traits of customers of the tenant.

15. The machine-readable medium of claim 13, wherein the operations further comprise extracting data from one or more data sources such that the business criteria are identified based on the extracted data, wherein the one or more data sources include one or more databases coupled to a model management server computing device.

16. The machine-readable medium of claim 15, wherein the operations further comprise feature engineering the data, wherein feature engineering comprises extracting features associated with at least one of the tenant and the customers, and transforming the extracted features into information offering one or more of the business preferences and the behavior traits.

17. The machine-readable medium of claim 13, wherein the operations further comprise evaluating credentials of the multiple models to determine suitably of each of the multiple models for the tenant, wherein passing a first model of the multiple models that is evaluated as suitable for the tenant and wherein failing a second model of the multiple models that is evaluated as unsuitable for the tenant.

18. The machine-readable medium of claim 17, wherein the operations further comprise transmitting the first model to the tenant for utilization of processes as determined by the tenant, wherein the first model is transmitted, over a communication network, to one or more client computing devices accessible to one or more users representing the tenant, wherein the second model is rejected and sent back for additional feature engineering, wherein the first and second models include machine learning models.
